(19) United States
(12) Patent Application Publication
(10) Pub. No.: US 2023/0230431 A1
(43) Pub. Date: Jul. 20, 2023

(54) ELECTRONIC LOCK CONFIGURED TO RECEIVE WIRELESS POWER TRANSMISSIONS

(71) Applicant: HAMPTON PRODUCTS INTERNATIONAL CORPORATION, Foothill Ranch, CA (US)

(72) Inventor: Kyrilous Basilious, Corona, CA (US)

(73) Assignee: HAMPTON PRODUCTS INTERNATIONAL CORPORATION, Foothill Ranch, CA (US)

(21) Appl. No.: 18/097,455

(22) Filed: Jan. 16, 2023

Related U.S. Application Data
(60) Provisional application No. 63/266,820, filed on Jan. 14, 2022.

(51) Int. Cl. G07C 9/00

(52) U.S. Cl. CPC G07C 9/00174; G07C 2009/00642

(57) ABSTRACT

An electronic lock is configured to receive a wireless power transmission from a portable electronic device such as a tablet or smartphone. The electronic lock can also be configured to simultaneously receive a data transmission from the smartphone requesting operation of a lock actuator of the electronic lock. Power from the wireless power transmission can be used to electrically power the microprocessor and the lock actuator.

### CROSS-REFERENCE TO RELATED APPLICATIONS

This application claims priority to U.S. Provisional Application No. 63/266,820, which was filed Jan. 14, 2022, the entirety of which is hereby incorporated by reference.

### BACKGROUND

The present disclosure relates to the field of electronic locking devices.

Electronic locks have become increasingly popular. Such locks typically include an electronic actuator configured to control a locking structure such as a deadbolt, latch, cam, or such in order to lock and unlock the electronic lock. An interface typically receives some input from a user in order to trigger operation of the actuator, and often a circuit including a microcontroller is employed to interact with the interface and, when appropriate, instruct operation of the actuator.

A battery is typically employed to supply power to various components of the lock. Such batteries can often supply sufficient power for months of operation. However, eventually such batteries will discharge, leading to the potential of the electronic lock becoming inoperable, and remaining so until the batteries are replaced or recharged.

### SUMMARY

The present disclosure discloses aspects that improve electronic locks by enabling an electronic lock to receive a wireless power transmission from a portable electronic device, such as a smartphone, which wireless power transmission can supply sufficient power so that the electronic lock can be operational even when the battery has fully discharged.

In accordance with one embodiment, the present specification provides an electronic lock assembly comprising a housing, a locking assembly, an actuator, and a power receiver. The actuator is configured to actuate the locking assembly from a locked position to an unlocked position, and is configured to be operable by electric power. The power receiver is within the housing and is configured to receive a wireless power transmission, the wireless power transmission providing electric power to the power receiver. Electric power from the power receiver can be communicated to the actuator.

Another embodiment additionally comprises a radio antenna configured to receive a data transmission, and a microprocessor configured to analyze the data transmission, wherein the microprocessor is configured to selectively direct operation of the actuator.

In a further embodiment the microprocessor and actuator are configured to receive electric power from the power receiver.

In another embodiment the power receiver is configured to receive the wireless power transmission at the same time the radio antenna receives the data transmission.

In still another embodiment there is no battery in communication with the actuator.

A further such embodiment additionally comprises a storage capacitor configured to receive electric power from the power receiver and to discharge at least a portion of the electric power to operate the actuator. Yet another such embodiment additionally comprises a microprocessor, and the storage capacitor is configured to discharge at least a portion of the electric power to operate the microprocessor.

Yet another embodiment additionally comprises a capacitor configured to receive electric power from the power receiver and to selectively discharge at least a portion of the electric power.

Still another embodiment additionally comprises a rechargeable battery, and wherein a portion of the electric power from the power receiver is directed to the rechargeable battery.

In accordance with another embodiment, the present specification provides a method of operating an electronic lock, comprising the electronic lock receiving a wireless power transmission, powering a processor of the electronic lock, receiving an authorization input, the processor validating the authorization input, and powering an actuator so as to unlock the electronic lock.

Some such embodiments can comprise receiving the wireless power transmission from a portable computing device.

Further such embodiments can comprise powering the processor using power received via the wireless power transmission.

Additional such embodiments can comprise communicating power from the wireless power transmission to an energy storage unit. Some such embodiments can comprise powering the processor using power from the energy storage unit.

A still further embodiment can comprise receiving the authorization input from the portable computing device.

### BRIEF DESCRIPTION OF THE DRAWINGS

FIG. 1 is a perspective exploded view of an embodiment of an electronic lock having inventive aspects;

FIG. 2 is a schematic diagram demonstrating wireless power transmission from a smartphone to an electronic lock in accordance with an embodiment;

FIG. 3 is a side view showing operation of an embodiment of an electronic lock installed on a door;

FIG. 4 is a diagram showing interaction of electronic structures of an electronic lock in accordance with an embodiment;

FIG. 5 is a side view showing operation of another embodiment of an electronic lock installed on a door; and

FIG. 6 shows operation of an embodiment in which an electronic lock is configured in a padlock style.

### DESCRIPTION

As will be discussed in more detail below, an electronic lock can be configured to receive a wireless power transmission from a user's smartphone or other mobile electronic device. The wireless power transmission can power operation of the electronic lock. The phone can also, and simultaneously, transmit a data signal to the electronic lock, which data signal can include a verification that the user is authorized to actuate the lock. The electronic lock, using power provided by the phone via the wireless power transmission, can process the data signal, recognize the user as being authorized for access, and then direct an actuator to operate a latch assembly to unlock the lock.

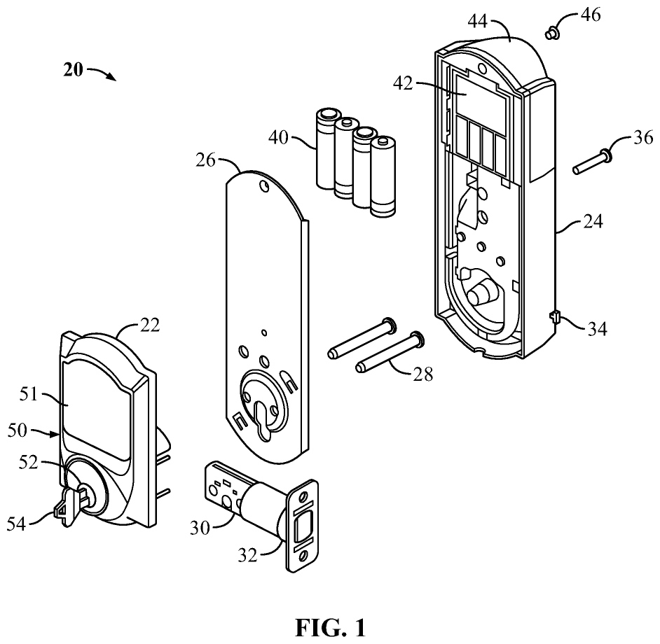

Electronic locks are enjoying increased popularity. Such locks can find varied uses, such as for residential locks, padlocks, and lockers, and encompass many different ways of operating. With initial reference to FIG. 1, an example electronic lock 20 is a residential deadbolt lock that includes an outside assembly 22 configured to fit on the outside surface of a residential door, and an inside assembly 24 configured to be located inside the residence. An inside mount plate 26 can be configured to fit flush on the inside surface of the door and be held in place with plate fasteners 28, which can also hold the outside assembly 22 in place from the inside. A latch assembly 30 can be configured to fit within the door and can include a latch bolt 32. An inside housing 34 can be configured to attach to the inside support plate 26 via a housing fastener 36. The inside housing 34 preferably can be configured to enclose an actuator, such as an electric motor or solenoid, that can be configured to actuate the latch assembly 30.

Electricity to power the actuator can be provided by one or more batteries 40 that can be enclosed within a battery compartment 42 defined within the inside housing 34. A battery access door 44, which can be secured by a battery door fastener 46, can provide access to the battery compartment 42 to enable replacement of the batteries 40.

The outside assembly 22 can include a user interface 50 configured to receive an input to trigger the actuator. The user interface 50 can be configured in many different ways to receive a variety of inputs. For example, the user interface 50 can be a touchscreen having a keypad configured so that a user can enter a code to trigger the actuator. In other embodiments the user interface 50 can include physical buttons as such a keypad. Still further embodiments of the user interface 50 can employ other input technologies. For example, the user interface 50 can include a fingerprint or eye scanner, and/or facial and/or voice recognition technology in order to verify a user is authorized for entry, and thus trigger the actuator. In yet additional embodiments, the outside assembly 22 can be configured to receive wireless signals, such as near field communication (NFC) inputs to verify user authorization to trigger the actuator.

Electronic locks 20 can also be configured as part of a so-called “smart” network, in which multiple powered devices within a residence or other structure are configured to communicate with one another and, in many instances, with a network with which a user can communicate with his own “smart” computing device (such as a tablet or phone) so that the user can monitor the condition of several devices, including the lock 20. Electronic locks 20 can also be configured to interact directly with a wireless local area network, such as via WiFi.

The illustrated electronic lock 20 includes an outside keyway 52 configured to accept actuation of the lock 20 via a traditional key 54 if the user wishes to bypass the electronic authorization features.

The embodiment illustrated in FIG. 1 presents just one example, and it is to be understood that electronic locks can be configured is many other ways. For example, many electronic locks do not include an outside keyway 52. Also, while some electronic locks allow replacement of batteries 40, some use rechargeable batteries 40, and may dispense with providing access to replace the rechargeable batteries. Often, the inside assembly 24 will include a USB port to enable recharging of the batteries 40.

One of the most common problems homeowners have with electronic locks is the battery in their system becoming fully discharged so that no power is available to receive input and trigger the actuator. To avoid this problem, electronic locks can include an alert system, such as an audible alert, warning light, and/or message communicated over a smart device network. It is incumbent on the user to change or recharge the batteries 40 of the electronic lock 20 as appropriate. Notwithstanding the warnings, lock batteries continue to become fully discharged, causing inconvenience to users.

Additionally, as shown in FIG. 1, the inside housing 36 of electronic locks 20 is often quite large to accommodate the batteries 40. Thus, electronic locks 20 often have bulky and unattractive housings made necessary by bulky, and sometimes unwieldy, batteries. Also, such batteries 40 typically are held within the inside housing 34, necessitating an electrical power connection through the door to the user interface 50 of the outside assembly 22.

Wireless power transfer is a technology that enables transfer of electrical power from one device to another without requiring physical electric contact between the devices. Wireless power transfer using inductive charging has become popular for charging mobile computing electronic devices such as smartphones, tablets, and smartwatches. A popular form of wireless power transfer for such devices is inductive charging—specifically resonant inductive coupling—according to the Qi standard. More recently, such technology has been further developed so that such mobile devices can not only be charged by such wireless power transfer, but, once charged, such mobile devices can charge other devices via wireless power transfer. This feature is often referred to as “reverse wireless charging”. Samsung™ generally refers to its version of this feature as “PowerShare”, while Google™ generally refers to its version of this features as “Battery Share”. Some such products are configured with a default condition of being able to be charged by receiving a wireless power transmission from a source such as a base station. Such products may require the user to manually actuate the reverse wireless charging capability.

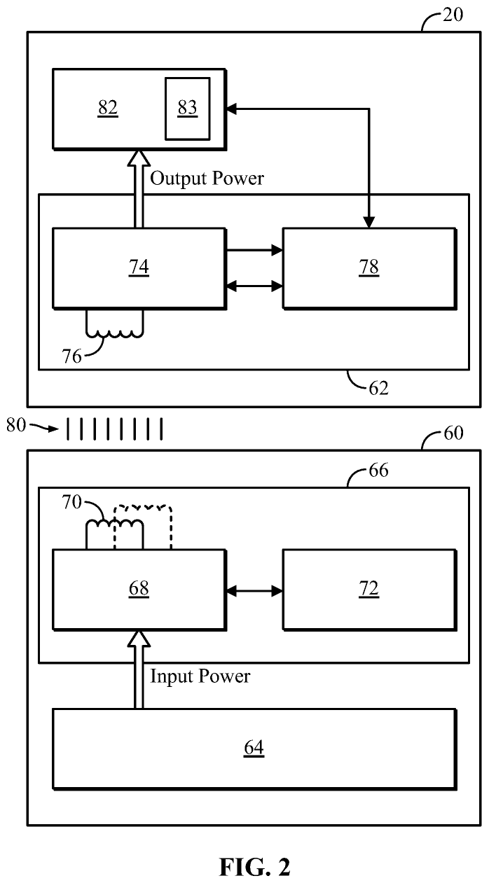

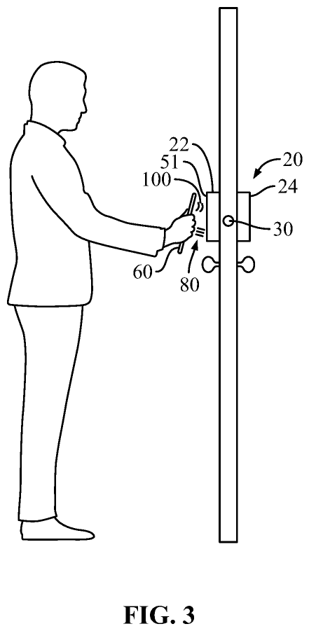

In a preferred embodiment, an electronic lock 20 is configured to receive electric power from a handheld or portable electronic device, such as a phone 60, tablet, or battery bank via reverse wireless charging. With reference next to FIGS. 2 and 3, an electronic lock 20 can include a power receiver module 62 within its outside assembly 22, which power receiver module 62 is configured to receive a wireless power transmission 80 from a mobile electronic device such as a user's smartphone 60. The phone 60, which as is typical includes a battery 64, includes a power transmitter module 66, which preferably can also be used to receive a wireless power transmission to charge the phone's battery 64. The power transmitter module 66 can include a power conversion unit 68 that includes one or more primary coils 70. A communications and control unit 72 can be configured to regulate the transferred power. The power receiver module 62 of the electronic lock 20 can have a power pick-up unit 74 that includes a secondary coil 76. A communications and control unit 78 can be configured to regulate the transfer of power. When the primary coils 70 are energized, a wireless power transmission 80, such as an oscillating magnetic field, is generated and received by the secondary coil 76.

Phones 60 that employ inductive charging according to the Qi standard can expect the wireless power transmission 80 to be effective and transmitting power over a relatively small distance, such as up to about 4 cm. Thus, as depicted in FIG. 3, a user can position their phone 60 at or close to the user interface 50 of the outside assembly 22 so that a wireless power transmission 80 from the phone 60 can be transferred to the lock 20. Although current embodiments employ the Qi standard, it is to be understood that other wireless power transfer technologies and standards can be used. For example, inductive charging according to the “PMA” standard can also be employed in some embodiments.

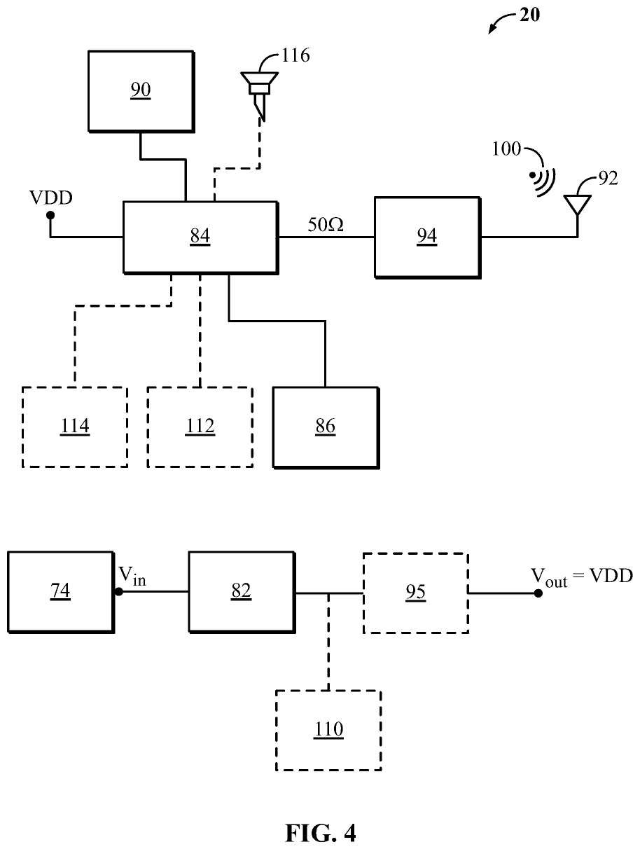

With reference again to FIG. 2 and additional reference to FIG. 4, power received by the power pick-up unit 74 can be communicated to a power conditioner 82 to be prepared for delivery to a microprocessor 84, which can be regulated by a system clock 86. Such power can further be directed to an actuator 90, such as an electric motor or solenoid, which can in turn actuate the latch assembly 30 to unlock the lock 20. In a preferred embodiment, the power conditioner 82 includes one or more capacitors configured to accept and clean up the transmitted power. One or more of the capacitors can be a storage capacitor 83, which can also be disposed within a circuit and configured to store a portion of the power received. A portion of such power can be retained after the phone 60 is removed, ending receipt of power. The power stored in the storage capacitor 83 can be used to power maintenance portions of the circuit, such as the clock 86 and/or basic functions of the microprocessor 84. In some embodiments the storage capacitor 83 can store enough power to actuate the actuator 90 at least once, and in some embodiments up to about 3-6 times without further charging.

In addition to providing the power to operate the electronic lock 20, the phone 60 can communicate the input to provide verification signaling the microprocessor 84 to operate the actuator 90. For example, many smartphones 60 are equipped with a short-range wireless communications capability such as near field communication (NFC) transmission capability. With specific reference to FIG. 4, the electronic lock 20 can be configured with an antenna 92 communicating with a radio 94, which together can receive and send NFC transmissions. The electronic lock 20 thus is configured to communicate data with the phone 60. For example, at the same time the phone 60 is powering the electronic lock 20 via a wireless power transmission 80, the phone 60 can also be sending a data signal 100 to the electronic lock 20. The data signal 100 can include a verification code that the microprocessor 84 can recognize as indicating that the bearer of the phone 60 is authorized to actuate the lock 20. Thus, the microprocessor 84 can signal operation of the actuator 90 to unlock the lock 20. Although the current embodiment employs NFC, it is to be understood that other short range wireless data transfer technologies can be employed, such as Bluetooth™, ultra-wideband or WiFi. Also, it is to be understood that any manner of user verification process can be employed to verify that the user of the phone 60 is authorized to actuate the lock 20.

Notably, various types of actuators and locking/latching mechanisms can be employed in an electronic lock that practices aspects as described herein. For example, the actuator can comprise a release mechanism comprising one or more parts that, when in an opened configuration, enables a user to manually unlatch the lock but prevents such manual unlatching when in a closed configuration. Specific examples of such structure would be the shackle of a padlock, which can be manually moved by the user only when the corresponding release mechanism is in an opened configuration. Also, such a release mechanism can be applied to a deadbolt, blocking operation of the deadbolt when in a closed configuration, but allowing a user to manually operate the deadbolt when in an opened configuration. In such versions, upon satisfaction of the user verification process, the release mechanism can be signaled and/or actuated to move to the opened configuration.

In one preferred embodiment, the electronic lock 20 has no battery, or at least no traditional battery configured to store enough energy for weeks or months of operation. Instead, power for operating all lock components comes from a wireless power transmission 80, which can be directed through one or more capacitors. As such, the electronic lock 20 may be in a sleep state when not in use. When the wireless power transmission 80 is received, the components wake up. For example, the radio 94 may begin scanning for NFC transmissions received by the antenna 92 after a wireless power transmission is received. Similarly, the microprocessor 84 can power-on, receiving the data signal 100 from the radio 94, analyzing same, and directing operation of the actuator 90 if the data signal 100 indicates that the user is authorized. When powered, the microprocessor 84 can be configured to accomplish other tasks, such as saving a log of the event in a memory, and/or preparing and sending a data transmission to the phone 60 and/or another network concerning the event, its status, or the like.

In a preferred embodiment, the user phone 60 includes an application configured to prepare and transmit the data signal 100, which preferably includes a data structure such as a code or other credential verifying that the user of the phone 60 is authorized to operate the lock 20. The application can include any number of security features to ensure that the user is, indeed, so authorized. Preferably, the application also automatically places the phone 60 in a reverse wireless charging mode so that when the phone 60 is placed adjacent the outside assembly 22, the phone 60 directs a wireless power transmission 80 to the electronic lock 20. Preferably, the data signal 100 is sent after the wireless power transmission 80 has been initiated and the lock 20 components powered up. But preferably the data signal 100 is transmitted while the wireless power transmission 80 is still active.

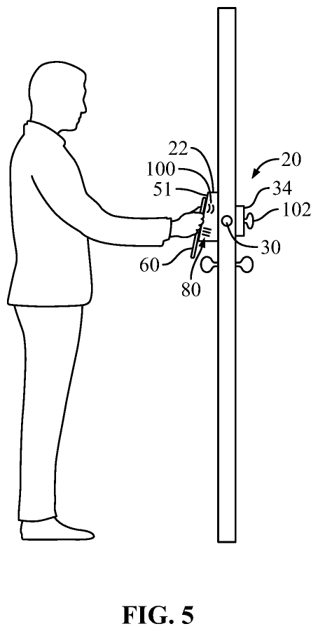

Embodiments of electronic locks 20 that employ no or reduced-capacity batteries 40 require substantially less physical volume within any housing, as bulky batteries are no longer required. With reference next to FIG. 5, in one embodiment, the electrical components of the electronic lock 20 can be contained within the housing of the outside assembly 22. Thus, the inside housing 34 can have a minimal size, appearing similar to a traditional deadbolt having simply an internal cover plate and an internal knob 102 for operating the latch assembly 30. Also, in the illustrated embodiment, the user interface 50 can include a pad 51 that can be flat and inclined at a 15-45° angle relative to horizontal so as to accommodate a user's phone 60 placed thereon. Resting the phone 60 directly on the surface of the pad 51 optimizes positioning so as to facilitate a wireless power transmission 100 while also enabling access to the phone screen.

With reference again to FIG. 4, in accordance with an optional embodiment, an energy storage unit 110 disposed in the line of power delivery can include a capacitor configured to store energy, being charged by the wireless power transmission 100. The energy storage unit 110 can include a switch controlled by the microprocessor 84 for regulating charging and discharging of the capacitor. Preferably, the capacitor stores sufficient energy for basic microprocessor 84 operation, and perhaps one or two actuator 90 unlocking or locking events. In yet another embodiment the energy storage unit 110 can include a small rechargeable battery sized for storing a relatively small charge similar to that of the storage capacitor 83.

In still further embodiments, a full-size battery unit 40 can be disposed within the inside housing 34, and the energy storage unit 110 could be part of the outside assembly 22, and could be configured to store only a small amount of energy in a manner as discussed above. The energy storage unit 110 can operate substantially independent of the battery unit 40, such as when the battery unit 40 employs non-rechargeable batteries.

In a yet additional embodiment, the energy storage unit 110 can comprise a full-size battery configured to operate the electronic lock 20 for months at a time, and can be part of a rechargeable battery unit 40 found in previous versions of electronic locks 20. In such an embodiment, structure can be provided to facilitate replacement or recharging of the battery 40. However, if the battery is not maintained, and becomes fully discharged, the electronic lock 20 will still operate by enabling reverse wireless charging of the lock 20 by the user's phone 60. As such, problems and inconvenience due to a lock battery dying can be avoided. Such battery 40 can be disposed within the inside housing 34 or be part of the outside assembly 22.

With continued reference to FIG. 3, additional embodiments can include one or more further optional features. For example, a spatial motion sensor 112 can be provided to sense when the electronic lock 20 is about to be used, so as to prompt the microprocessor 84 to wake systems in order to speed response. Most preferably, in this embodiment, at least a portion of charge is retained in the energy storage unit 110. Additional input structures 114, such as physical buttons and biometric sensors, can also be employed, and indicators such as LED lights or a display can signal whether the lock 20 is operable and/or recognizes a user's credential/code and/or can communicate status messages. Further, instead of or in addition to an electric motor or solenoid, one or more piezoelectric motors 116 can be employed to actuate the latching mechanism 30.

In one embodiment, the electronic lock 20 can include an NFC tag 95, which can be programmed with information about the lock, lock identification, required credentials, and other information necessary for operation and/or authentication of the lock user. The NFC tag can be activated and charged by the NFC equipped phone 60 or device. The extra power from the NFC tag 95 can start a processor or microprocessor 84 necessary to negotiate Qi power. Once the lock 20 is ready to receive power from the phone via Qi, the microprocessor 84 can enable authentication leading to actuation of the actuator 90 to unlock the lock 20.

In one embodiment, the lock 20 can communicate data to the phone concerning the amount of power received by the lock 20 from the phone 60. The phone 60 can perform calculations to determine power transmission efficiency based on this data as well as data from the phone concerning the power transmitted by the phone. Other methods of determining efficiency can be employed. The phone can notify the user of power transmission efficiency through an interface such as an app, website, text, or other notification means. The phone 60 can also wirelessly communicate the power transmission efficiency to the lock 20 so that the lock can notify the user of such efficiency via the lock interface 50 (e.g., keypad, LED, audio, and display).

If power transmission is insufficient or power transmission efficiency is below a certain threshold, the phone 60 or lock 20 can notify the user so that the user can move the phone closer. In some embodiments for safety purposes, a foreign object can be detected by the charging circuitry in the lock 20 such as by measuring the Q factor (Q=2πfL/R) prior to power transmission. If a foreign object is determined to be present, the lock 20 can notify the user of the foreign object detection status on the lock 20 or through the phone 60. The foreign object can then be removed so that power and data transmission between the phone 60 and lock 20 can proceed appropriately.

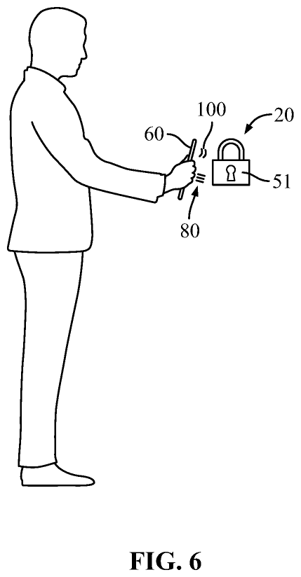

With reference next to FIG. 6, it is to be understood that aspects discussed above can be employed in other variations. For example, FIG. 6 shows an electronic lock 20 configured as a padlock. The padlock can include an interface pad 51 configured to accommodate the user's phone 60. Electronic components such as delineated in FIGS. 2 and 4 can be configured so that the phone 60 can power the lock 20 via a wireless power transmission 80, and a user authentication data signal 100 can simultaneously be sent by the phone via NFC or other wireless methods. Other input structures can also be employed to verify the user's authentication credentials.

The embodiments discussed above have disclosed structures with substantial specificity. This has provided a good context for disclosing and discussing inventive subject matter. However, it is to be understood that other embodiments may employ different specific structural shapes and interactions.

Although inventive subject matter has been disclosed in the context of certain preferred or illustrated embodiments and examples, it will be understood by those skilled in the art that the inventive subject matter extends beyond the specifically disclosed embodiments to other alternative embodiments and/or uses of the invention and obvious modifications and equivalents thereof. In addition, while a number of variations of the disclosed embodiments have been shown and described in detail, other modifications, which are within the scope of the inventive subject matter, will be readily apparent to those of skill in the art based upon this disclosure. It is also contemplated that various combinations or subcombinations of the specific features and aspects of the disclosed embodiments may be made and still fall within the scope of the inventive subject matter. Accordingly, it should be understood that various features and aspects of the disclosed embodiments can be combined with or substituted for one another in order to form varying modes of the disclosed inventive subject matter. Thus, it is intended that the scope of the inventive subject matter herein disclosed should not be limited by the particular disclosed embodiments described above, but should be determined only by a fair reading of the claims that follow.

What is claimed is:

1. An electronic lock assembly, comprising:
a housing;
a locking assembly;
an actuator configured to actuate the locking assembly from a locked position to an unlocked position, the actuator configured to be operable by electric power; and
a power receiver within the housing and configured to receive a wireless power transmission, the wireless power transmission providing electric power to the power receiver; and
wherein electric power from the power receiver can be communicated to the actuator.

2. The electronic lock assembly of claim 1 additionally comprising a radio antenna configured to receive a data transmission, and a microprocessor configured to analyze the data transmission, wherein the microprocessor is configured to selectively direct operation of the actuator.

3. The electronic lock assembly of claim 2, wherein the microprocessor and actuator are configured to receive electric power from the power receiver.

4. The electronic lock assembly of claim 2, wherein the power receiver is configured to receive the wireless power transmission at the same time the radio antenna receives the data transmission.

5. The electronic lock assembly of claim 1, wherein there is no battery in communication with the actuator.

6. The electronic lock assembly of claim 5 additionally comprising a storage capacitor configured to receive electric power from the power receiver and to discharge at least a portion of the electric power to operate the actuator.

7. The electronic lock assembly of claim 6 additionally comprising a microprocessor, and wherein the storage capacitor is configured to discharge at least a portion of the electric power to operate the microprocessor.

8. The electronic lock assembly of claim 1 additionally comprising a capacitor configured to receive electric power from the power receiver and to selectively discharge at least a portion of the electric power.

9. The electronic lock assembly of claim 1 additionally comprising a rechargeable battery, and wherein a portion of the electric power from the power receiver is directed to the rechargeable battery.

10. A method of operating an electronic lock, comprising:
the electronic lock receiving a wireless power transmission;
powering a processor of the electronic lock;
receiving an authorization input;
the processor validating the authorization input; and
powering an actuator so as to unlock the electronic lock.

11. The method of claim 10, comprising receiving the wireless power transmission from a portable electronic device.

12. The method of claim 11, comprising powering the processor using power received via the wireless power transmission.

13. The method of claim 11, comprising communicating power from the wireless power transmission to an energy storage unit.

14. The method of claim 13, comprising powering the processor using power from the energy storage unit.

15. The method of claim 11, comprising receiving the authorization input from the portable electronic device.
